(19) United States
(12) Patent Application Publication
(10) Pub. No.: US 2009/0239436 A1
(43) Pub. Date: Sep. 24, 2009

(54) Web-strength-enhanced armor with embedded, bead-porous fabric sub-layer

(76) Inventors: Thomas S. Ohnstad, Salem, OR (US); Russell A. Monk, Salem, OR (US)

Correspondence Address: ROBERT D. VARITZ, P.C., 4915 SE 33RD PLACE, PORTLAND, OR, 97202, US

(21) Appl. No.: 12/381,432

(22) Filed: Mar. 11, 2009

Related U.S. Application Data
(60) Provisional application No. 61/069,468, filed on Mar. 12, 2008.

(51) Int. Cl. B32B 27/12; B05D 7/24

(52) U.S. Cl. 442/294; 427/407.1

(57) ABSTRACT

Spray-formed, anti-burst, leak-self-sealing coating structure applicable to the outside surface of a fuel container, and an associated application methodology. In an operative condition relative to such a surface, the coating structure includes (a) a solid, continuous-phase body of fuel-reactive, high-elastomeric material in the form of an expanse having an inner side applied to such a surface, and a spaced, outer side, (b) a field of distributed, fuel-reactive, fuel-imbiber beads embedded in and throughout the expanse of said body, generally spaced from, and centrally between, the body's inner and outer sides, but exposed to neither such side, and (c) an anti-burst fabric web having meshes formed by elongate, stretch-resistant fibers extending generally centrally within and throughout bead field. Meshes in the fabric web, and beads in the bead field, are relatively sized appropriately to permit the ready mesh-through-passage of beads during spray-formation of the coating structure.

### CROSS-REFERENCE TO RELATED APPLICATION

This application claims filing-date priority to currently co-pending, U.S. Provisional Patent Application Ser. No. 61/069,468, filed Mar. 12, 2008, for “Web-Strength-Enhanced Armor with Embedded, Bead Porous Fabric Sub-Layer”. The entire disclosure content of that provisional application is hereby incorporated herein by reference.

### BACKGROUND AND SUMMARY OF THE INVENTION

The present invention relates to spray-formed, anti-burst, leak-self-sealing coating structure applicable to the outside surface of a fuel container. It is also referred to herein as involving (a) web-strength-enhanced, anti-fuel-leak, anti-burst, fuel-container coating structure having embedded, bead-porous, anti-burst fabric web, and, (b) in accordance with the above-selected title, as concerning web-strength-enhanced armor with an embedded, bead-porous fabric sub-layer. How these several, various ways of verbally “visualizing” the invention will become apparent.

The invention also features a unique methodology for spray-forming such a coating structure.

Recently developed for self-sealing certain types of puncture-produced, liquid(typically petroleum-based fuel)-container leaks is a unified, layered, spray-formed liquid-contact-reactive, high-elastomeric-body coating, or coating structure, including, in a central layer region, an embedded population of liquid(fuel)-contact-reactive, liquid(fuel)-imbiber beads. The liquid reaction exhibited by these coating components, i.e., by the high-elastomeric material and the bead components, is a fuel-imbibing, swelling, and material-congealing leak-sealing reaction. The elastomeric material in this overall coating structure essentially takes the form of a body of solid, continuous-phase material. A consequence of this is that, while the structure of the coating includes, functionally, plural layers, an actual cross section of the coating would not reveal any line of elastomeric-material demarcation between adjacent layers. This same structural consideration is found and exists, as will be seen, in the coating structure of the present invention.

U.S. Pat. No. 7,169,452 B1, a good background document, describes this previously-developed protective coating structure.

The present invention offers an important modified and improved (for certain applications) version of that prior-developed, spray-formed coating structure (and a related formation methodology), which modified version furnishes enhanced armoring behavior capable of dealing both with leakage from a punctured-fuel-container, and with an event, or events, leading to container-bursting. This potential bursting problem, triggered typically, though not always, from a shock wave initiated by an external explosion, is specifically addressed by the modified coating structure proposed by this invention through the embedded incorporation within that structure of a woven-fibre, anti-stretch, fabric web of a tension-robust material such as a woven aramid-fibre web of material.

Importantly, this embedded web material is chosen to have what is referred to herein as an appropriate mesh porosity (i.e., selected, minimum-dimension mesh size) which enables it easily to be embedded, during spraying, within the layer-thickness confines of that layer region of the overall coating which also includes the mentioned embedded liquid(fuel)-imbiber beads. Web embedding “within the thickness confines” just mentioned means that the embedded web is disposed within a layer “field” wherein the also embedded liquid-imbiber beads reside within the meshes, and on the opposite sides, of the fabric web. Accordingly, the liquid-imbiber beads and the fabric web, in accordance with this invention, are co-selected so that the beads have a maximum-dimension constraint that enables them to “pass readily through the mesh porosity” of the meshes in the web.

In this context, we have found a very satisfactory selection for beads and web material to be one wherein the beads have maximum, outside-dimension sizes lying generally within the range of about 200-microns to about 300-microns, with the fabric web having a mesh size which will accommodate the free passage through its meshes of beads characterized with this just-mentioned, maximum dimensionality.

Accordingly, a preferred and best-mode embodiment of the invention takes the form of a spray-formed, anti-burst, leak-self-sealing coating structure applicable to the outside surface of a fuel container, which coating structure, in operative condition relative to such a surface, includes (a) a solid, continuous-phase body of fuel-reactive, high-elastomeric material in the form of an expanse having an inner side applied to such a surface, and a spaced, outer side, (b) a field of distributed, fuel-reactive, fuel-imbiber beads embedded in and throughout the expanse of the elastomeric body, generally spaced from, and centrally between, the body's inner and outer sides, but exposed to neither such side, and (c) an anti-burst fabric web having meshes formed by elongate, stretch-resistant fibers extending generally centrally within and throughout the bead field.

A preferred and best-mode method for forming this coating structure relative to the outside surface of a fuel container, includes, in any appropriate order (such the order presented illustratively below herein), the steps of (a) placing a web of anti-burst fabric, formed of elongate, stretch-resistant fibers united to form meshes having a predetermined minimum dimension, in substantially uniformly spaced, confronting relation to a selected area of such a container surface, and, in succession, (a) first, spraying the selected area solely with a high-elastomeric, fuel-reactive material to create an inner coating-structure layer having a first, desired thickness, (b) thereafter, continuing coating-structure formation by spraying, toward the same area, a blend including the same, just-mentioned, high-elastomeric material and a population of fuel-reactive, fuel-imbiber beads including beads substantially all of which have a size enabling them to pass through the minimum-dimension meshes in the fabric web, thus to create an intermediate coating-structure layer possessing a second, desired thickness, with the beads therein distributed within the meshes, and on opposite sides, of the fabric web, and (c) thereafter, completing coating-structure formation by repeating just-above-presented spraying step (a), thus to create an outer coating-structure layer possessing a third, desired thickness.

These and other features and advantages which are offered by the structure and methodology of the present invention will become more fully apparent as the detailed description of the invention which now follows is read in conjunction with the accompanying drawings.

### DESCRIPTION OF THE DRAWINGS

FIG. 1 is a simplified, fragmentary cross section of a coating structure prepared in accordance with a preferred and best-mode embodiment of the present invention applied to the outside surface in a petroleum fuel container.

FIG. 2 is a changed-scale, fragmentary plan view taken generally along the line 2-2 in FIG. 1.

FIG. 3 is a simplified, block/schematic diagram generally illustrating the coating-structure formation methodology of the present invention.

### DETAILED DESCRIPTION OF THE INVENTION

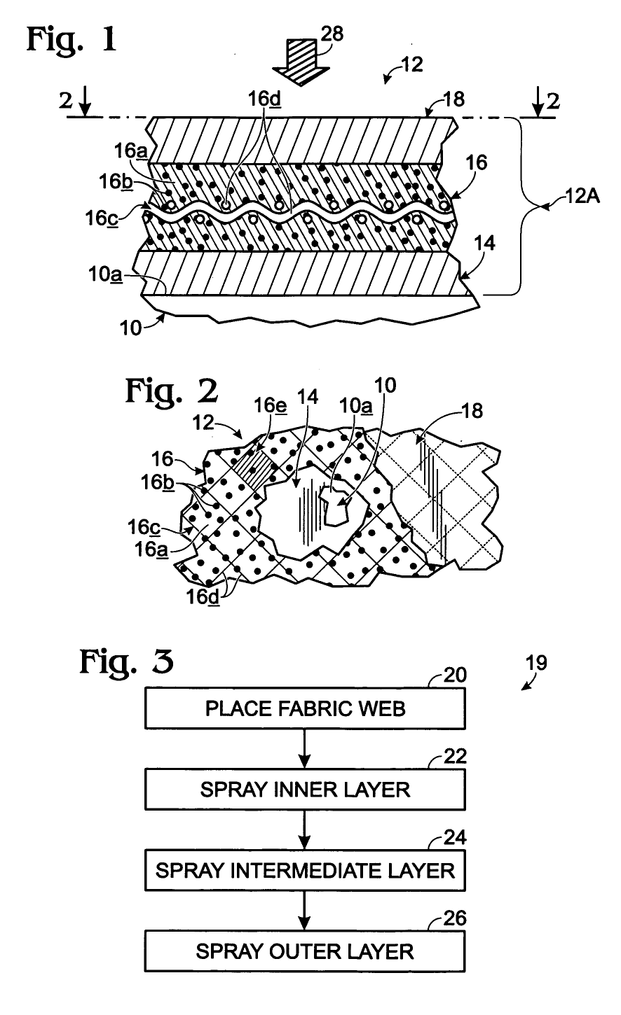

Turning now to the drawings, and beginning with FIGS. 1 and 2, indicated generally at 10 is a petroleum fuel container having an outside surface 10a to which has been applied, in accordance with a preferred and best-mode manner of implementing the present invention, a spray-formed, anti-burst, leak-self-sealing coating structure generally shown at 12.

Coating structure 12 is applied to container surface 10a in a manner which will be more fully described shortly to form of what is referred to herein as a coating expanse which lays over to protect a selected surface area (user chooseable) of surface 10a. This coating-structure expanse is specifically formed herein illustratively with inner, intermediate, and outer layers 14, 16, 18, respectively. While individual layer is thickness herein is not any part of the present invention, these layers might have the following, respective thicknesses: layer 14, about ⅛-inches; layer 16, about 3/16-inches; and layer 18, about ⅛-inches.

The mentioned fuel-imbiber beads preferably take the form of the solid-phase, polymer-bead product made by Imbibitive Technologies America, Inc. in Midland, Mich., and possessing a product identifier IMB230300.

Inner layer 14 and outer layer 18 have essentially the same construction, in that they are formed entirely of a sprayed-applied, high-elastomeric, fuel-reactive material, and preferably a two-component, polyurethane, high-elastomer product made by Rhino Linings, USA, a company based in San Diego, Calif., sold by that company under the trademark TUFF STUFF®. Intermediate layer 16 differs from layers 14, 18 in that, while it includes a main layer-body 16a of the same high-elastomeric material employed solely in layers 14 and 18, layer 16 additionally includes an embedded distribution of fuel-reactive, fuel-imbiber beads 16b distributed in an embedded an nominally shrouded condition within elastomeric material 16a. Layer 16 further includes, in a condition generally centrally disposed between layers 14, 18, what is referred to herein as an anti-burst fabric web 16c formed of interwoven, elongate, stretch-resistant, aramid fibers 16d that define meshes such as that mesh which is shown shaded at 16e in FIG. 2.

According to an important feature of the present invention, the maximum size of beads 16b, and the minimum size of a mesh 16e in web 16c, are chosen in such a fashion that, during spray-formation of coating structure 12, as will shortly be explained, it is possible for beads to pass freely and readily through the open spaces of the meshes. In relation to the preferred fuel-imbiber bead product mentioned above, we have found that it is appropriate to utilize a fabric web having a minimum mesh size, or dimension, generally in the range of about 200-microns to about 300-microns, with a preferred minimum dimension being about 300-microns.

The nature of the higher-elastomeric material, as mentioned generally earlier herein, which is employed in each of the three layers in coating structure 12 is such that, at the conclusion of spray formation of the coating structure, this elastomeric material, as indicated generally on the right-hand side of FIG. 1 by the reference identifier 12A, takes the form of what is referred to herein as a solid, continuous-phase body of high-elastomeric material. As a consequence, this continuous-phase body of material works in a highly integrated and overall cooperative way during self-sealing of a container-10, puncture-wound fuel leak. Further, and as was also mentioned earlier herein, what appear in the drawing figures, and particularly in FIG. 1, as lines of demarcation between the three layers included in coating structure 12 would not be apparent in a real-life look at a cross section of a coating structure made in accordance with the present invention.

Turning attention now to FIG. 3 in the drawings, this figure illustrates, in a simplified, block/schematic form at 19, and in four, arrow-connected blocks 20, 22, 24, 26, the preferred and best-mode coating-structure-formation methodology which is proposed by the present invention. With respect to what is specifically shown in this figure, it should be understood that the mentioned blocks which are employed to illustrate a formation methodology in accordance with practice of the present invention do not necessarily define describe a sole, rigid sequence of step implementation.

In particular, and as will become apparent to those generally skilled in the art, the particular step—fabric web placement—which is represented by block 20 in FIG. 3 may actually take place at a point in time which either lies (a) between the steps that are represented by block's 22, 24, or (b), even during implementation of the formation step which is specifically represented by block 24. It is intended that fabric web 16c end up disposed in coating structure 12 generally centrally (relative to layers 14, 18) within layer 16, with high-elastomeric material 16a, and beads 16b occupying portions of layer 16 disposed both on opposite sides, and within the meshes, of the web. This condition can easily be achieved not only by the specific sequence of formation steps pictured in FIG. 3, but also by the modified sequences just suggested above at (a) and (b) in this paragraph of description.

Notwithstanding this important statement about the non-rigidity of the order of steps specifically illustrated for description purposes herein in FIG. 3, the spray-formation steps of the invention, as shown in this figure, can be described in the following fashion: (1) placing a web of anti-burst fabric, formed of elongate, stretch-resistant fibers united to form meshes having a predetermined minimum dimension, in substantially uniformly spaced confronting relation to a selected area of the outside surface in a fuel container, and (2), in succession, (a) first, spraying the selected area solely with a high-elastomeric, fuel-reactive material to create an inner coating-structure layer having a first, desired thickness, (b) thereafter, continuing coating-structure formation by spraying, toward the same area, a blend including the same, just-mentioned, high-elastomeric material and a population of fuel-reactive, fuel-imbiber beads including beads substantially all of which have a size enabling them to pass through the minimum-dimension meshes in the fabric web, thus to create an intermediate coating-structure layer possessing a second, desired thickness, with the beads therein distributed within the meshes, and on opposite sides, of the fabric web, and (c) thereafter, completing coating-structure formation by repeating just-above-presented spraying step (a), thus to create an outer coating-structure layer possessing a third, desired thickness.

Returning attention for a moment to FIG. 1, shown generally at 28 in this figure is a large, shaded, downwardly pointing arrow. This arrow is employed herein to represent, variously, two, different, impending kinds of events—(1) a leak-producing puncture wound, and (2) an external-explosion shock wave—which may bring into functional play either the anti-leak, self-sealing capability of the coating structure of the present invention, and/or the anti-burst capability of this coating structure.

Viewing arrow 28 first of all as a symbol indicating an about-to-occur puncture wound, if such a wound occurs, the self-sealing, anti-fuel-leak behavior of coating 12 is, and will be, substantially the same as that behavior which is described in above-referred-to U.S. Pat. No. 7,169,452 B1. Accordingly, reference is here made specifically to the text in that patent regarding this leak-sealing activity.

Staying for a moment with the event of a puncture wound, while such a wound will not necessarily trigger, in addition to a fuel leak, a container burst, it could do so. If that—i.e., a puncture-wound-initiated container burst—occurs, then the embedded, anti-burst, anti-stretch fabric web 16c, coupled cooperatively with the behavior of the high-elastomeric material which embeds this web, function(s) effectively to minimize outwardly propelling fragmentation of container 10, or of any portions of this container which may fracture and yield in the event of such a burst.

Considering the alternative situation wherein arrow 28 indicates an impending, impacting shock wave, produced (typically) by the occurrence of some external explosion, such a shock-wave impact may cause a bursting explosion of container 10, a container event calling for an anti-burst response, similar to that just described above, from anti-burst fabric web 16c working in cooperation with the embedding, high-elastomeric body material in the coating structure of the invention. Such a response is in fact exactly what occurs in accordance with the capabilities of the invention.

Accordingly, a unique anti-leak, anti-burst protective coating structure for use on the outside surface of a fuel container has been described and illustrated herein. Additionally, a unique methodology for forming such a coating structure has been proposed and illustrated—this methodology featuring the employment of specially size-related, (a) anti-burst, fabric web meshes, and (b) fuel-reactive, fuel-imbiber beads, that cooperatively allow for coating-structure formation in a relatively continuous, simple spray-application procedure. This methodology, and the associated, size-special material-employment just mentioned, enable fuel-imbiber beads to be blended in a spray flow of high-elastomeric material so as to be incorporated easily at appropriate regions inside the overall coating structure of the invention. In particular, the beads are permitted to flow freely, as necessary, through open meshes in the incorporated fabric web so as to permit the creation of a central coating-structure layer wherein both high-elastomeric material, and imbiber beads, become deployed effectively not only on opposite sides of the centrally embedded anti-burst fabric web, but also within the meshes, per se, in that web.

Accordingly, while a preferred and best-mode embodiment of the structure of the invention, as well as a preferred and best-mode manner of practicing the invention, along with several, proposed, modified forms and practices associated with the invention, have been described and illustrated herein, it is appreciated that variations and modifications may be made without departing from the spirit of the invention.

We claim:

1. Spray-formed, anti-burst, leak-self-sealing coating structure applicable to the outside surface of a fuel container, said coating structure, in operative condition relative to such a surface, comprising
a spray-formed, solid, continuous-phase body of fuel-reactive, high-elastomeric material in the form of an expanse having an inner side applied to such a surface, and a spaced, outer side,
a spray-formed field of distributed, fuel-reactive, fuel-imbiber beads embedded in and throughout the expanse of said body, generally spaced from, and centrally between, the body's said inner and outer sides, but exposed to neither such side, and
an anti-burst fabric web having meshes formed by elongate, stretch-resistant fibers extending generally centrally within and throughout said field.

2. The coating structure of claim 1, wherein said fibers take the form of aramid fibers.

3. The coating structure of claim 1, wherein the beads in said field of beads have a known maximum outside dimension, and said fabric web possesses a known minimum mesh size appropriate to accommodate through-passage, during spray-application formation of said coating structure, of beads possessing the mentioned, maximum outside dimension.

4. The coating structure of claim 3, wherein the mentioned maximum outside dimension is about 300-microns.

5. The coating structure of claim 3, wherein the mentioned, maximum outside dimension lies within the range of about 200-microns to about 300-microns.

6. The coating structure of claim 5, wherein said fibers take the form of aramid fibers.

7. A method of forming an anti-burst, leak-self-sealing coating structure on the outside surface of a fuel container comprising, in any appropriate order, the steps of
placing a web of anti-burst fabric, formed of elongate, stretch-resistant fibers united to form meshes having a predetermined minimum dimension, in substantially uniformly spaced, confronting relation to a selected area of such a surface, and,
in succession,
(a) first, spraying the selected area solely with a high-elastomeric, fuel-reactive material to create an inner coating-structure layer having a first, desired thickness,
(b) thereafter, continuing coating-structure formation by spraying, toward the same area, a blend including the same, just-mentioned, high-elastomeric material and a population of fuel-reactive, fuel-imbiber beads including beads substantially all of which have a size enabling them to pass through the minimum-dimension meshes in the fabric web, thus to create an intermediate coating-structure layer possessing a second, desired thickness, with the beads therein distributed within the meshes, and on opposite sides, of the fabric web, and
(c) thereafter, completing coating-structure formation by repeating just-above-presented spraying step (a), thus to create an outer coating-structure layer possessing a third, desired thickness.
